(19) United States
(12) Patent Application Publication
(10) Pub. No.: US 2013/0012054 A1
(43) Pub. Date: Jan. 10, 2013

(54) ELECTRIC PLUG

(75) Inventors: Jens Andresen, Blomberg (DE); Thomas Fuhrer, Blomberg (DE); Karsten Krome, Detmold (DE); Detlef Nehm, Schieder-Schwalenberg (DE); Ralf Feldner, Detmold (DE); Jens Franke, Blomberg (DE)

(73) Assignee: Phoenix Contact GmbH & Co. KG, Blomberg (DE)

(21) Appl. No.: 13/638,098

(22) PCT Filed: Jun. 17, 2011
(86) PCT No.: PCT/EP2011/060168

§ 371 Date: Sep. 28, 2012

(30) Foreign Application Priority Data
Jun. 18, 2010 (DE) 10 2010 017 458.0

(51) Int. Cl. H01R 13/00

(52) U.S. Cl. 439/476.1

(57) ABSTRACT

The invention relates to an electric plug, in particular a charging plug for a motor vehicle, comprising a housing and a handle for holding the electric plug, wherein the housing comprises a plug-in section, a cable connection opening and a cable conduit, the plug-in section comprises a plurality of electric contacts for plugging into a socket with contacts. A cable can be routed in the cable conduit from the cable connection opening to the plug-in section and can be electrically contacted there to the electric contacts. The cable connection opening may be arranged in a region between the plug-in section and the end of the gripping section which is remote from the plug-in section. In this way, the electric plug that is provided is such that heating of the handle can be avoided and the electric plug can also be used well and ergonomically by smaller individuals.

The invention relates to an electric plug having a housing and a handle for holding the electric plug, wherein the housing has a plug-in section, a cable connection opening and a cable conduit, the plug-in section has a plurality of electric contacts for plugging into an electric socket and for contacting mating contacts provided there, the cable connection opening is provided for inserting and/or removing an electric cable, the cable is guidable in the cable conduit from the cable connection opening to the plug-in section, where it can be brought into contact electrically with the electric contacts, and the handle has a gripping section for being gripped by a person's hand and is attached to the housing in such a way that the gripping section does not surround the cable connection opening or the cable conduit.

Such electric plugs are known from practice in particular as charging plugs for a motor vehicle. With the increased popularity of electric vehicles, it has become necessary to make available easily handled options for recharging the batteries of electric vehicles. To this end, charging stations have been developed, at which electric automobiles can be “filled” with electricity in an operation that resembles filling a vehicle with gasoline or diesel at a traditional filling station.

To “fill” or recharge an electric vehicle, it is connected to the charging station via a cable which may either be fixedly connected to the electric automobile or to the charging station, but at any rate must also be connected by plug at the other end. To conform to this pluggability requirement, electric plugs which can also be handled safely and reliably even by lay people have been developed, namely in particular plugs have been developed that can be used without any risk to a person using them. In particular these electric plugs should be easy for anyone to plug in and unplug. This is also true for small delicate people in particular, who are not as strong and must also be able to handle such a plug with the electric cable connected to it and do so easily and safely.

Such charging plugs are known now from practice for electric cars having a housing with a plug-in section and a handle, wherein the plug-in section and the handle run approximately perpendicular to one another. At the lower end of the handle, the cable is inserted into the housing, so that the cable is guided through the handle to the plug-in section, where it is electrically contacted with electric contacts on the electric plug. Handling the charging plug in a manner like that with a gun is thus made possible in this way so that plugging and/or unplugging of the charging plug in the horizontal direction is to be supported.

However, it has been found that with such charging plugs, the handle formed by a portion of the housing itself is guided through the cable and must in the meantime be designed with a very large diameter so that it is difficult to grip the handle and in particular to reach entirely around it with a person's hand, in particular when the user is a smaller delicate person. Moreover, in the case when using direct current as the charging current in particular, substantial heating of the cable may occur, so that the handle and the guide for the cable through the handle are both heated to a great extent. This is not only unpleasant for the user but may actually make it impossible to use the handle without protective gloves in particular after a lengthy charging process when there may be very extreme heating of the handle.

These problems can be solved by a design which is also known from practice and in which a handle is provided and is mounted on the housing in such a way that an area of the handle that is provided as a gripping section does not include and/or surround the area of the housing where the cable passes through the housing. Such a design should also have the advantage that the dimension of the actual gripping section is freely selectable and thus can conform to the ergonomic requirements without having to take into account boundary conditions determined by the housing and/or the cable such as a required minimum diameter. However, experience has shown that such charging plugs having a handle attached separately to the housing are both difficult to handle and difficult to operate.

Against the background of this situation, the object of the present invention is to provide such an electric plug, in particular a charging plug for a motor vehicle in which heating of the handle can be prevented and the plug can still be handled ergonomically and well even by small and delicate persons.

This object is achieved according to the invention by the subject matters of the independent claims. Advantageous embodiments of the invention are defined in the dependent claims.

To this extent, one solution to the problems on which the invention is based is an electric plug, in particular a charging plug for a motor vehicle, having a housing and a handle for holding the electric plug, such that the housing has a plug-in section, a cable connection opening and a cable conduit, the plug-in section comprises a plurality of electric contacts for plugging into an electric socket and for contacting mating contact provided there; the cable connection opening is provided for inserting and/or removing an electric cable; the cable can be guided in the cable conduit from the cable connection opening to the plug-in section and can be contacted electrically there with the electrical contacts, and the handle comprises a gripping section for gripping by the human hand and is attached to the housing in such a way that the gripping section does not surround the cable connection opening and the cable conduit, characterized in that the cable connection opening is provided in an area between the plug-in section and the end of the gripping section facing away from the plug-in section.

It is thus an important point of the invention that the electric plug has a housing with a handle attached to it such that the gripping section of the handle, i.e., the area which should be gripped by a person's hand, is arranged so that it does not surround and/or enclose the cable conduit through which a cable which is optionally is to be passed. With such a design it is now provided in particular that the cable connection opening, i.e., the area in which the cable is guided into and/or out of the housing, is not provided on the most rear and/or on the lowest end of the housing, typically below the handle, but instead is provided between the plug-in section and the end of the gripping section of the handle facing away from the plug-in section.

In other words, this means that with horizontal alignment of the plug-in section which represents the natural and conventional alignment for plugging into a respective electric socket, an arrangement of a cable mounted on the housing beneath the gripping section can be achieved. This means that according to the invention the advantages of the two electric plugs mentioned above can be combined, namely ergonomic and simple handling of the electric plug, even for weaker persons, while avoiding heating of the gripping section of the handle.

In this context, according to a preferred refinement of the invention it is provided that the cable connection opening is arranged in an area beneath the gripping section. In this way it is possible to achieve the result very easily that a cable attached to the electric plug is also situated beneath the gripping arm section, which has the ergonomic advantages mentioned above.

Furthermore, it is preferably provided that the cable conduit and/or the gripping section is bent at an angle so that it runs in the longitudinal direction of the plug-in section in its area facing the plug-in section, and in its area facing the cable connection opening it runs in a direction which forms an angle α with the longitudinal direction of the plug-in section, where it holds that 120°≦α≦150°, preferably 130°≦α≦140°.

If the cable conduit is angled in this way, then in the forward area, i.e., in the area leading to the plug-in section, this achieves the effect that the cable can be contacted easily with the electric contact provided there because of its course in the longitudinal arrangement of the plug-in section—namely, a corresponding design corresponds to a typical and well-tested arrangement of housing and cable in relation to one another.

Due to the angling of the cable guide channel in the rear area, i.e., in the area leading to the cable connection opening, it is easier to lead the cable out of the housing obliquely downward so that the aforementioned ergonomic advantages can be achieved in this way.

With a corresponding angling of the gripping section of the handle, this achieves the advantage that the electric plug can rest on a person's hand, typically on parts of a person's index finger, namely practically “hanging” there, practically on the front area of the electric plug, running parallel to the plug-in section, while the rear area is the area actually gripped by a person's hand with which the electric plug can be manipulated, in particular moved back and forth and brought into the correct position and/or alignment. A very preferred embodiment in this context is when the cable conduit and the gripping section run parallel to one another in at least some sections, or preferably completely.

According to a preferred refinement of the invention it is also provided that the gripping section of the handle has an area running parallel to the longitudinal direction of the plug-in section, and the cable connection opening is provided beneath this area. In the handling of the handle described above, namely when the electric plug “hangs” on areas of the index finger of the hand and the plug is manipulated by the hand holding the rear area of the gripping section, an even greater ergonomic effect is achieved through the design described here. A cable supplied to the electric plug can be provided essentially directly beneath the front area of the gripping section running parallel to the longitudinal direction of the plug-in section.

Finally, according to a preferred refinement of the invention, it is provided that the area of the gripping section of the handle facing away from the plug-in section protrudes beyond the cable connection opening in the longitudinal direction of the guide channel. This means that the rear area of the gripping section of the handle protrudes downward and/or to the rear beyond the area of the cable connection opening. This also facilitates ergonomic handling of the entire electric plug in that such a guide of a cable supplied to the electric plug is made possible, resulting in only minor forces, which must be overcome by a user to correctly plug it in and unplug it, typically horizontal plugging and/or unplugging of the electric plug.

The invention also relates to an arrangement of an electric plug as described above with an electric cable attached to it such that the cable is passed through the cable connection opening and the cable conduit into the housing of the electric plug and is electrically contacted with the electric contacts, characterized in that when the electric plug is held on the gripping section of the handle, this results in an alignment of the housing in which the longitudinal axis of the plug-in section forms an angle β with the horizontal, such that −12°≦β≦12° preferably −7°≦β≦7° and most especially preferably −4°≦β≦4°.

In this context it is preferred in particular that the angle β is achieved when it holds for the length 1 of the freely hanging cable that 70 cm≦1≦150 cm, preferably 80 cm≦1≦140 cm and most especially preferably 90 cm≦1≦130 cm.

These embodiments of a combination of an electric plug described above with an electric cable attached to it, as described above, has proven to be especially preferred ergonomically because in this way a fully balanced system can be implemented, whose resting position is characterized in that the longitudinal direction of the plug-in section runs essentially in the horizontal direction. As already mentioned above, this is the typical direction for plugging in and unplugging the electric plug from a corresponding electric socket, which is provided on an electric vehicle or a charging station, for example.

In addition, according to a preferred refinement of the invention, it is provided that the housing is designed in one piece and the cable is held in the housing by means of a cable tension release crimping sleeve. A very stable design and very high cable extraction forces are made possible in this way.

Finally the invention also relate to the use of an electric plug as described previously and/or an arrangement of an electric plug with a cable for charging an electric vehicle as also described previously. The electric plug may be pluggable into an electric vehicle as well as into the charging station—alternatively or in addition—by means of a corresponding electric socket.

Thus the following functions, effects and advantages can be achieved in particular with this invention and with the preferred refinements described above:

It is not necessary to provide a sheathed and less expensive housing nor is a housing of two half shells which are difficult to seal necessary. Instead preferably a closed housing, i.e., in one piece is provided on which a contact insert can be inserted into it from the front and can be protected from the penetration of dust and moisture by means of a radial seal.

Due to the arrangement of the cable connection opening according to the invention in an area between the plug-in section and the end of the gripping section of the handle facing away from the plug-in section, an oblique cable outlet downward can be achieved, preventing the cable from developing kinks and thus significantly improving the ergonomics. This is true in particular because charging cables for electric vehicles typically have a very large diameter and are very heavy, often with five conductors each having a diameter of 16 mm², so that on the whole a diameter of 30 mm or more of the electric cable is achieved.

The electric plug according to the invention may be designed so that it sits in the hand in such a way that it swings like a pendulum in a horizontal position, e.g., also due to the cable attached to it; in this horizontal position, the longitudinal direction of the plug-in section runs essentially horizontally. In this way, the electric plug can be plugged into a corresponding electric socket which may be provided at a charging station or on an electric vehicle in a particular convenient manner.

Due to the fact that the gripping section of the handle does not surround a cable inserted into the housing, the heating of the cable, which amounts to as much as 40 K during the charging operation, is not transferred to the handle, and the pulling and pushing forces can be introduced exactly in the direction of the plug-in operation without tilting or twisting of the electric plug, which is a considerable advantage at plug-in forces of up to 80 N.

A releasable lock may be provided between the electric plug and a corresponding electric socket by way of a rocker lever, for example, which is provided on the electric plug and can be operated with the thumb in a spring-supported mechanism. The corresponding pull-out forces here preferably amount to at least 500 N.

The invention is explained in greater detail below with reference to the accompanying drawings on the basis of preferred exemplary embodiments.

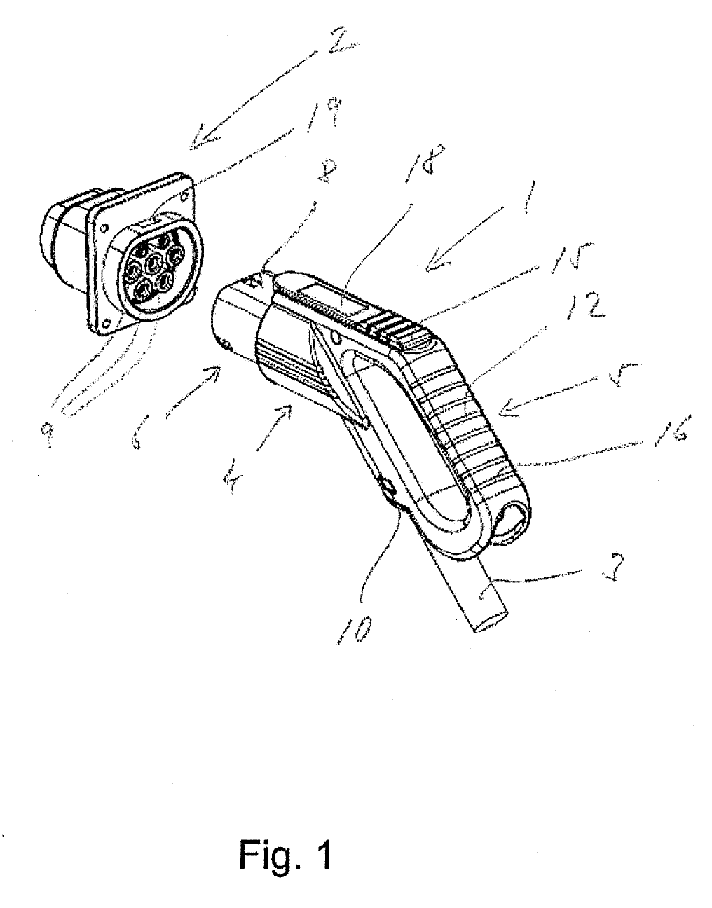

FIG. 1 shows an electric plug according to a preferred exemplary embodiment of the invention with the respective electric socket in a perspective view from the rear,

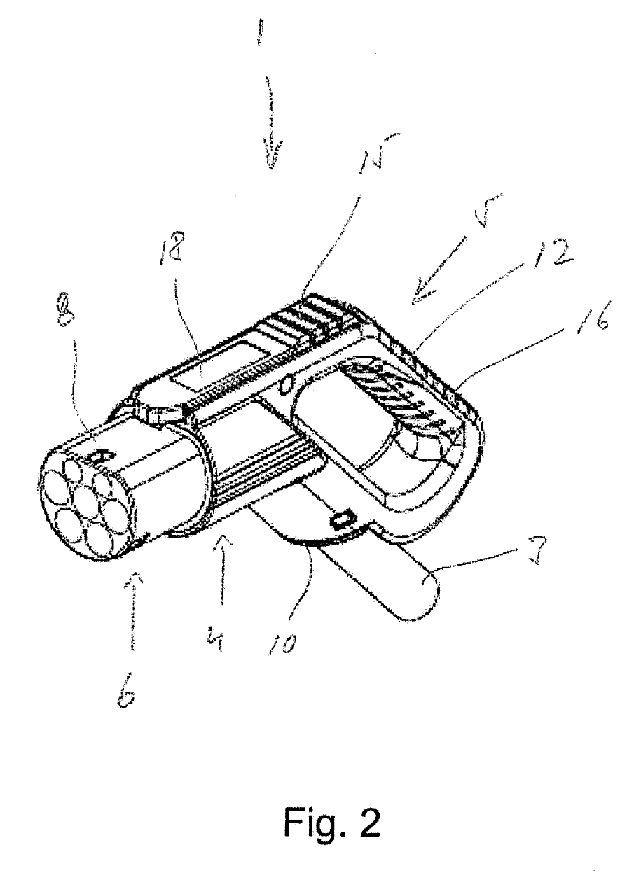

FIG. 2 shows the electric plug according to the preferred exemplary embodiment of the invention in a perspective view from the front,

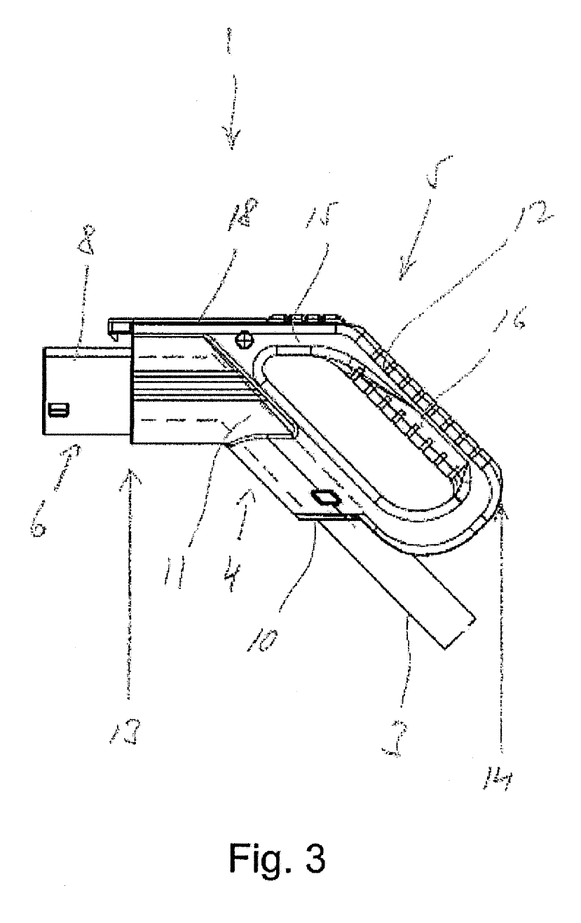

FIG. 3 shows the electric plug according to the preferred exemplary embodiment of the invention in a side view and

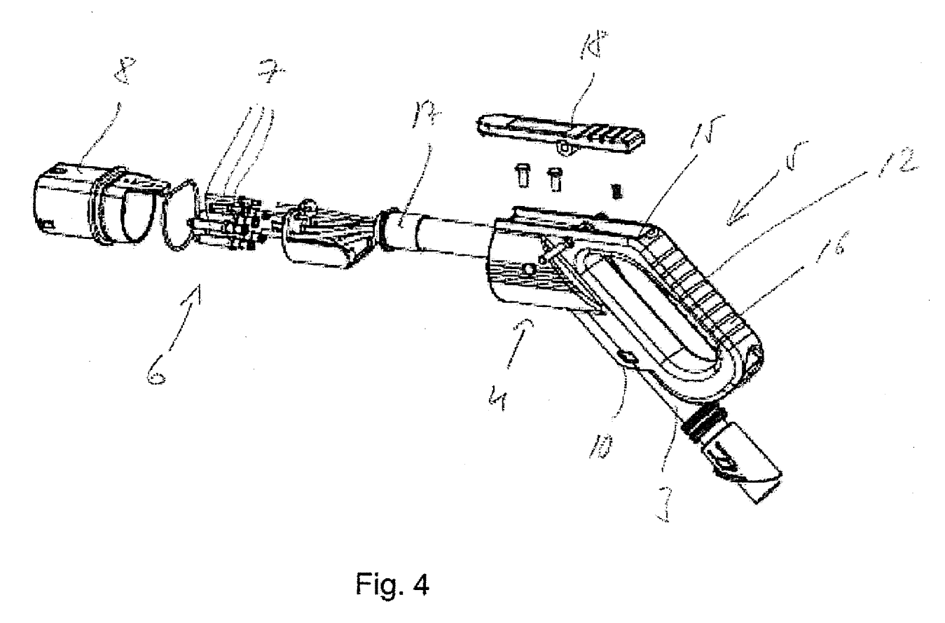

FIG. 4 shows the electric plug according to the preferred exemplary embodiment of the invention in a perspective exploded diagram.

The preferred exemplary embodiment of the invention, which is described below, always shows an electric plug with a cable attached to it, but the present invention also relates to such an electric plug without such an electric cable.

FIG. 1 shows an electric plug 1 according to the preferred exemplary embodiment of the invention, which is described here together with a corresponding electric socket 2, into which the electric plug 1 can be inserted. The electric plug 1 is a charging plug for a motor vehicle (not shown here), namely an electric car. By means of the electric plug 1, an electric car which is provided with an electric socket 2 can be connected to a charging station (not shown further). The connection is implemented by a cable 3 which is fixedly connected to the charging station and can also be contacted by plugging it into the charging station.

The design of the electric plug 1 according to the present preferred exemplary embodiment of the invention is now as follows:

The electric plug 1 has a housing 4 and a handle 5 for holding the electric plug 1. The housing 4 has a plug-in section 6 which has a plurality of electric contacts 7, as shown in FIG. 4. In plug-in section 6 the electric contacts 7 are surrounded by an electric wall 8. As also shown in FIG. 1, the plug-in section 6 of the electric plug 1 is provided for plugging it into the electric socket 2 and for contacting the mating contact 9 provided there.

Furthermore, the housing 4 has a cable connection opening 10 through which the cable 3 is inserted into the housing 4 of the electric plug 1 as shown in FIG. 3 in particular. Within the housing 4 a cable conduit 11 is provided as shown with the broken lines in FIG. 3 because it would visible only in a sectional view. The cable 3 passes from the cable connection opening 10 through the cable conduit 11 to the electric contacts 7 in the plug-in section 6.

As shown in all the figures, the handle 5 is integrally molded in one piece on the housing 4 and has a gripping section 12 suitable for being gripped in a person's hand. The handle 5 with its gripping section 12 is attached to the housing 4 in such a way that the gripping section 12 does not surround and/or enclose the cable connection opening 10 and the cable conduit 11. In other words, this means that the handle 5 with its gripping section 12 does not run around the cable 3 which is guided into the housing 4; in other words, the gripping section 12 is arranged at a distance from the cable 3. This presents the handle 5 in particular the gripping section 12 from also heating up greatly due to the heating of the cable 3.

With regard to the arrangement of the cable connection opening 10, this is provided in an area between the plug-in section 6 and the end of the gripping section 12 facing away from this. This area is indicated with the area borders 13 and 14 in FIG. 3. Thus the cable connection opening 10 is also provided in an area beneath the gripping section 12. The gripping section 12 as shown in FIG. 3 in particular consists of two sections, namely a first section 15 running parallel to the longitudinal axis of the plug-in section 6 and a second section 16 running parallel to the area of the cable conduit 11 facing the cable connection opening 10. Thus the gripping section 12 of the handle 5 is bent at exactly the same angle as the cable conduit 11.

With the gripping section 12 the first area 15 facing the plug-in section 6 runs parallel to the longitudinal axis of the plug-in section 6 while the rear second area 16 is bent downward at an angle, namely at an angle between 130° and 140°.

The same thing is also true of the cable conduit 11, which points obliquely downward in its rear area while it runs parallel to the longitudinal axis of the plug area in its forward area facing the plug area 6. Moreover, the cable conduit 10 [sic; 11] and the gripping section 12 of the handle 5 thus run parallel to one another in essential sections.

With regard to the cable connection opening 10, it is also true with the exemplary embodiment described here that the cable connection opening 10 is provided beneath the area 15 of the gripping section 12 running parallel to the longitudinal direction of the plug-in section 6. In this way, when holding the electric plug 1 with one hand around the gripping section of the handle 5, it is possible for the electric plug 1 to swing so that its equilibrium position is in an essentially horizontal alignment of the longitudinal axis of the plug-in section 6. Moreover, it is true that the second area of the gripping section 12 which faces away from the plug-in section 6 protrudes to the rear in the longitudinal direction of the cable conduit 11 and protrudes downward beyond the cable connection opening 10 which can also be seen in FIG. 3.

The dimensions of the cable 3 connected to the electric plug 1 are such that an alignment of the housing 4 is achieved when holding the gripping section 12 of the handle 5 of the present electric plug 1, such that the longitudinal axis of the plug-in section 6 forms a very small angle with the ground, i.e., with the horizontal, such that this angle does not exceed 4°. This facilitates manual insertion and removal of the electric plug 1 in the horizontal direction. The length of the cable 3, at which an angle of 4° or less is obtained, can be achieved in the present case with a free cable length of 90 cm to 130 cm, i.e., the length of the cable 3 between the cable connection opening 10 and the ground, on which the cable 3 rests.

Finally, it should also be pointed out with the exemplary embodiment of the present invention described here, the housing 4 is designed in one piece and the cable 3 is held in the housing 4 by means of a cable tension release crimping sleeve 17 which ensures very high cable extraction forces.

Furthermore, a rocker lever 18 is also provided on the electric plug 1, making it possible to achieve a lock between the electric socket 2 and the electric plug 1 as shown in FIG. 1 for example. The rocker lever 18 can be operated with one's thumb in a spring-supported mechanism and when the rocker lever 18 is locked in a corresponding catch opening 19 in the electric socket 2, extraction forces of more than 500 N may be achieved.

### LIST OF REFERENCE NUMERALS

Charging plug 1
Electric socket 2
Cable 3
Housing 4
Handle 5
Plug-in section 6
Electric contacts 7
Wall 8
Mating contacts 9
Cable connection opening 10
Cable conduit 11
Gripping section 12
Front area border 13
Rear area border 14
First section of the gripping section 15
Second section of the gripping section 16
Cable tension release crimping sleeve 17
Rocker lever 18
Catch opening 19

1.-10. (canceled)

11. An electric plug comprising:
a housing, wherein the housing comprises a plug-in section, a cable connection opening, and a cable conduit; and
a handle associated with the housing for holding the electric plug;
wherein the plug-in section comprises a plurality of electric contacts configured to plug into an electric socket and contact mating contacts provided there;
wherein the cable connection opening is provided for inserting and respectively removing an electric cable;
wherein the cable conduit is configured such that the electric cable can be guided from the cable connection opening to the plug-in section into electrical contact with the electric contacts;
wherein the handle comprises a gripping section for being gripped by a person's hand and is attached to the housing in such a way that the gripping section does not surround the cable connection opening and the cable conduit;
wherein the cable connection opening is provided in an area between the plug-in section and the end of the gripping section facing away from the plug-in section; and
wherein the gripping section comprises a region running parallel to the longitudinal direction of the plug-in section, and the cable connection opening is provided beneath the region.

12. The electric plug according to claim 11, characterized in that the cable connection opening is provided in an area beneath the gripping section.

13. The electric plug according to claim 11, characterized in that the cable conduit and/or the gripping section is/are angled such that it runs in an area facing the plug-in section in the longitudinal direction of the plug-in section and runs in a direction fanning an angle α with the longitudinal direction of the plug-in section in its area facing the cable connection opening, wherein 120°≦α≦150°.

14. The electric plug according to claim 11, characterized in that the gripping section runs in its area facing away from the plug-in section parallel to the cable conduit in its area facing away from the plug-in section.

15. The electric plug according to claim 11, characterized in that the area of the gripping section facing away from the plug-in section protrudes beyond the cable connection opening in its portion facing away from the plug-in section in the longitudinal direction of the cable conduit.

16. A system comprising:
an electric plug according to claim 11 in an arrangement with an electric cable attached to the electric plug;
wherein the electric plug is configured such that the electric cable is guided through the cable connection opening and the cable conduit into the housing of the electric plug into electrical contact with the electric contacts;
wherein, when the electric plug is held on the gripping section of the handle, an orientation of the housing is provided in which the longitudinal axis of the plug-in section forms an angle β with the horizontal, wherein −12°≦β≦12°.

17. The system of claim 16, wherein the angle β is achieved when it holds for the length 1 of the freely hanging cable that 70 cm≦1≦150 cm.

18. The system of claim 16 wherein the housing is configured in one piece and the cable is held in the housing via a cable tension release crimping sleeve.

19. The method of using an electric plug according to claim 11 for charging an electric vehicle.

20. The method of using the electric plug of a system according to claim 16 for charging an electric vehicle.

21. The electric plug according to claim 13, wherein 130°≦α≦140°.

22. The system of claim 16 wherein −7°≦β≦7°.

23. The system of claim 16 wherein −4°≦β≦4°.

24. The system of claim 17 wherein 80 cm≦1≦140 cm.

25. The system of claim 17 wherein 90 cm≦1≦130 cm.
